(19) United States
(12) Patent Application Publication
(10) Pub. No.: US 2008/0317023 A1
(43) Pub. Date: Dec. 25, 2008

(54) Method and Device for the Configuration of New and Modified Services in a Switching Unit of an Ip Multimedia Subsystem

(75) Inventor: Martin Stuttgen, Munchen (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Nokia Siemens Networks GmbH & Co. KG, Munich (DE)

(21) Appl. No.: 12/087,241

(22) PCT Filed: Sep. 7, 2006
(86) PCT No.: PCT/EP2006/008719

§ 371 Date: Jun. 27, 2008

(30) Foreign Application Priority Data
Dec. 29, 2005 (DE) 10 2005 063 048.0

(51) Int. Cl. H04L 12/56

(52) U.S. Cl. 370/389

(57) ABSTRACT

A switching unit in an IP multimedia subsystem includes at least one operator service list. A new service and/or a modification in an existing service is configurable in the at least one operator service list by means of an administration unit. The services configured in the at least one operator service list for a user registering in the switching unit is applicable to the user.

The invention relates to a switching unit for an IP multimedia subsystem, particularly such a subsystem specified according to 3GPP and to a method for operating such a switching unit.

The “3rd Generation Partnership Project (3GPP)” is a collaboration agreement which was established in December 1998. This collaboration agreement brings together a large number of bodies for telecommunication standards which are called “Organizational Partners”. The current partners in this sense are ARIB, CCSA, ETSI, ATIS, TTA and TTC. In founding the 3GPP, it was the intention to specify globally applicable technical specifications and technical reports for a third generation mobile radio network which is based on an advanced GSM core network or otherwise advanced radio access technology such as, e.g. General Packet Radio Service (GPRS) and Enhanced Data rates for GSM Evolution (EDGE). At the same time, it is intended to support both the technologies in Frequency Division Duplex (FDD) and in Time Division Duplex (TDD) methods as part of “Universal Terrestrial Radio Access (UTRA)”.

The IMS (IP Multimedia Subsystem) specified by the 3GPP, compare 3GPP TS 23.002 “Network Architecture”; www.3gpp.org, contains an HSS (Home Subscriber Service) which administers user-specific data in a user profile. In this user profile, there are service-specific components which, for example, specify which application services (e.g. Push To Talk, Presence Service) are provided for the user. If a network operator offers new application services or modifies existing services which are to be made accessible for all users located in the network of the operator, a comparatively high administrative cost can arise for the network operator in order to configure these new and/or modified services in all user profiles.

In 3GPP UMTS Reference Architecture, edition 5, the user is informed of each service in his user profile. Thus, each user profile must be changed in order to provide the newly introduced service to the users. In edition 6 (Release 6), user profiles have been created for the first time which can be shared by a number of users (so called “shared iFC” according to 3GPP TS 29.229 V6.2, chapt. 7.1.1 and chapt. B2). In this context, it is disadvantageous, however, that this defined approach can lead to erratic behavior in the IMS because, in parallel with the configuration of the shared iFCs, these correspondingly configured shared iFCs must also be made known in the logical switching unit (Serving Call Session Control Function—S-CSCF) via a configuration of the S-CSCF system in order to obtain, on the one hand, optimization of the data maintenance and, on the other hand, also to keep the system transparent to the extent that the S-CSCF also actually knows when it has to look in the personal user profile and when it has to look in a shared user profile. The network operator therefore has the obligation of ensuring consistent configuration in the HSS and in the S-CSCF. The network operator, therefore, must pay attention to the fact that the priority of the user-specific services and of the global services (shared iFCs) are unambiguously configured in the HSS. With the number of increasing and different user profiles, therefore, the risk also increases, unfortunately, that the configuration can be obscure and thus errored.

The present invention is, therefore, based on the object of specifying a satisfactory solution to this problem. In this context, it should be simple to configure new and/or modified services in a simple and consistent manner both in terms of the system and of the method.

According to the invention, this object is achieved with respect to the switching unit in that a switching unit in an IP multimedia subsystem is provided, said switching unit comprising at least one operator service list, a new service and/or a modification in an existing service being configurable in the at least one operator service list by means of an administration unit, and the services configured in the at least one operator service list for a user registering in the switching unit being applicable to said user.

According to the invention, the aforementioned object is achieved with respect to the method in that a method for operating a switching unit in an IP multimedia subsystem is provided in which:
a) at least one operator service list is defined for the switching unit,
b) a new service and/or a modification in an existing service is configured in the at least one operator service list by means of an administration unit; and
c) the services configured in the at least one user service list for a user registering in the switching unit are applied to said user.

In this way, a direct configuration capability exists in the switching unit S-CSCF which enables the network operator to efficiently provide new user-independent services. The operator service list(s) is/are used as (a) configuration table(s) providing in the structure thereof all of the data required to call up application services via the ISC (IMS Service Control) interface. A configuration of the services in the individual HSS (Home Subscriber Service) is therefore not required inter alia for this type of global services, which significantly relieves the network operator. At the same time, the problem of inconsistency as a result of a different configuration of the services in the HSS and in the S-CSCF can also be eliminated.

In order to be able to arrange certain services with different prioritization and/or hierarchical linking, a first operator service list and the second operator service list can be provided, the processing of which is intended for different trigger-related levels of hierarchy. In this respect, a preferred embodiment of the invention can provide, for example, that first all services defined in the first operator service list, then the services listed for the user in a home subscriber list and, finally, all services defined in the second operator service list can be executed. In this manner, the order in which services are called up also remains transparent for network operators.

The operator service lists are configured in the S-CSCF by means of OAM (Organization, Administration and Management) functionalities and can be extended or modified at any time without impairing the operation of the S-CSCF. However, so that inconsistencies in the system in running transactions due to changes in configuration can be reliably eliminated, it is advantageous if in the case of an update of the first and/or the second operator service list, all SIP transactions already set up can still be executed with the old configuration level of the first and/or the second operator service list.

A suitable structure for the operator service list can provide that the operator service list comprises for each service an application address, a filtering rule and a priority allocation. The services can thus be unambiguously called up via the ISC interface.

Further advantageous embodiments of the invention can be found in the remaining subclaims.

Exemplary embodiments of the invention will be explained in greater detail with reference to a drawing, in which:

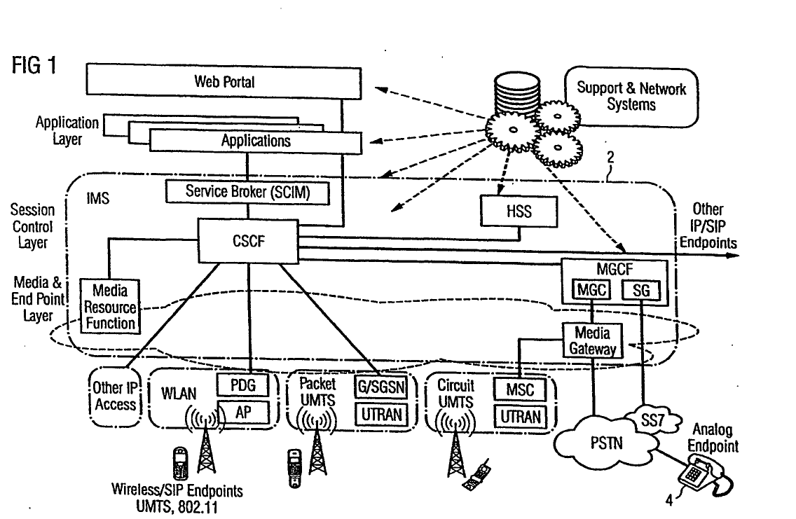

FIG. 1 shows the basic configuration of an IMS subsystem specified according to 3GPP;

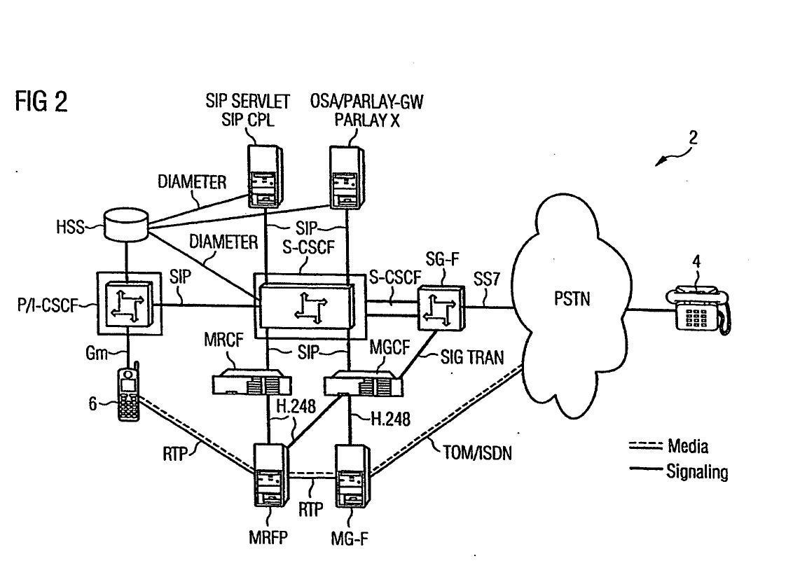

FIG. 2 shows the basic division of media and signaling data in the subsystem according to FIG. 2; and

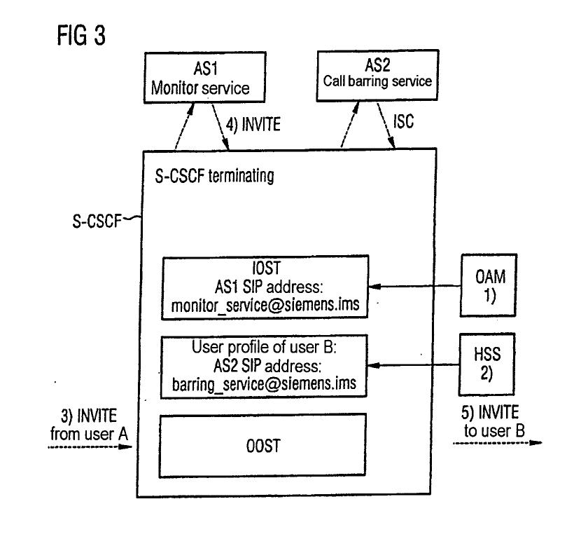

FIG. 3 shows a diagrammatic representation of the process sequence with the introduction of a new service.

FIG. 1 shows the basic logical configuration of an IMS subsystem 2 specified according to 3GPP. In this context, the IMS subsystem 2 is actually a collection of logic functions which can be considered as three functional layers:
a) the media and end point layer;
b) a call or session control layer; and
c) an application layer.

In this arrangement, SIP signaling is started or ended in the media and end point layer, for example in order to set up sessions between one or more users or to deliver bearer services such as, e.g. the conversion of words with an analog or digital format into IP packets. This layer also comprises the media gateways which convert the VoIP data streams into time-slot-oriented formats which are needed for a public switched telecommunication network (PSTN).

The media server in this layer provides for a wide range of media-related services such as, for example, conferencing, play announcements, collecting in-band signaling tones, speech recognition and speech synthesis.

With respect to the principles of rationalization underlying the IMS architecture, the resources of the media server are divided among all applications. Thus, for example, each application which needs announcements to be played can use this shared media server. Such applications comprise, for example, straightforward voice mail, advanced 800 messaging services and interactive VXML speech recognition and synthesis. The media servers of this layer can also support non-telephony functions such as, for example, the replication of media for push-to-talk services.

The call and/or session control layer comprises the essential elements of the IMS architecture, that is to say, especially the SIP proxy call session control function (CSCF). This central feature of the IMS architecture provides for the registration of terminals or end points in the network and for routing SIP signaling messages to the appropriate application server. The CSCF also interacts with the network access and transport layer in order to be able to provide a certain quality of services for all services.

The call and/or session control layer also comprises the element of the database of the home subscriber server (HSS) which is also central to this architecture and in which the service profile belonging to each user is stored. This service profile of the end user stores all service information of this end user and his priority services at a central point. This also comprises the current registration information of an end user such as, for example, his IP address, roaming information and telephony services (e.g. call forwarding information).

Due to this centralization of the user information, the applications can jointly use this user information for generating unified personal data records, multi-client type presence information and composite services. This central data keeping also basically simplifies the administration of the user data and generally secures a consistent view of the active subscribers seen over all services, with the restrictions mentioned initially.

This layer also comprises the actual media gateway control function (MGCF). This functionality enables the SIP signaling to work with different types of signaling which are used by the media gateways, that is to say, for example, generally the session management protocol H.248—also called Megaco. The MGCF manages the distribution of the sessions over a multiplicity of media gateways whilst a media resource function (MRF) produces a comparable function for the media server.

The application layer, finally, comprises the actual application server which provides the logic for operating the end user services. In this context, the IMS architecture, together with the SIP signaling, are sufficiently flexible for being able to support a wide range of telephony and non-telephony services.

For this purpose, a telephony application server (TAS) provides the fundamental call processing services such as, for example, digit analysis, routing, call establishments, call delay, call forwarding and conferencing. The TAS houses the logic which allows the media servers to provide the suitable tones and announcements for dealing with the call. Furthermore, the TAS analyzes the dialed number when the call comes from a public telecommunication network, in order to enable the media gateway control functionality to route the call to the desired destination. This control function then instructs the media gateway concerned to convert the received time-slot-oriented voice data stream of a PSTN into a data stream with IP real-time transport protocol. This data stream is then conducted to the IP address of an IP-capable telephone. Furthermore, the TAS supplies the so-called filtering functions which are known as intelligent network call trigger points in the IMS. This means that the TAS stops further processing of the call and looks in the corresponding user profile whether certain services are to be applied to the call at this time when the call comes to such a trigger point. Using this user profile, the TAS then determines the services in question and correspondingly formats an SIP signaling message for handing the control of the call to the corresponding application server.

In this context, a single IMS can comprise a multiplicity of TASs which in each case supply specific features for particular types of devices or end points. Using the SIP signaling, a server for a number of applications can be enabled to handle calls between different classes of devices.

Furthermore, the TAS contains an IP multimedia service switching function (IM-SSF) which is essentially a translation function. The IM-SSF enables SIP messages to act in conjunction with messages of other signaling protocols such as, e.g. CAMEL and ANSI-41. This interaction allows IP-capable devices supported by IMS to access a large range of telephony services such as calling name services, 800 services, local number portability (LNP) services and one number services.

In addition, further supplementary application servers for telephony services can be linked in the application layer. Thus, separate servers independent of the remaining network can be provided which can be activated by trigger points and can thus produce supplementary telephony services, either at the beginning, at the end or during a call. Such services are, for example, click-to-dial, click-to-transfer, click-to-conference, voicemail services, interactive voice response services, VoIP virtual private network services, pre-paid billing services and inbound/outbound call blocking services.

A type of elements in the application layer which differs from this is an application server based on SIP which must be placed outside the telephony/caller environment. This application server can interact with software in the devices in order to offer services such as instant messaging, push-to-talk over cellular (PoC) and presence-enabled services. Implementing these SIP-based services in the shared IMS architecture enables telephony and non-telephony services to interact as a result of which a multiplicity of services can be provided which have both a telephony component and a non-telephony component. An example of such a service is a converging click-to-contact buddy list which indicates the presence of the user and his availability information and supplies a point-and-click interface via a multiplicity of communication services (telephony, instant messaging and PoC).

A further essential element of the application layer is the open service access gateway (OSA-GW) which allows the network operators to offer the development and implementation of services to their customers so that their VoIP network resources can be effectively employed. Thus, for example, a company can have the wish of rendering some back office processes accessible to direct voice so that, for example, a call is automatically initiated when an order is delivered. This process can then be triggered, for example, by a location information item of a wireless PDA carried by the delivery person.

It is frequently also true that application developers in the company have a strong IT background but are not at all familiar with the multiplicity of complex signaling protocols such as SS7, ANSI-41, SIP and ISDN. To get around this problem, the application layer of the IMS offers interfaces for applications (API) which are simple to program, in order to enable the entry into the telephony world. This interaction of SIP and API is made possible in this manner in the OSA-GW.

FIG. 2 then shows in a basic representation the division of the user data stream (called media or also payload) and the signaling data stream in the IMS 2 according to FIG. 1. The user data stream (dot-dashed lines) is conducted via ISDN to a media gateway functionality MG-F and is then converted into a packet-oriented data stream and forwarded in the real time transport protocol RTP via a media resource function processor MRFP to a mobile terminal 6. The actual signaling of this payload delivery is effected via SIP and H.248 messages which are managed by a serving call session control function S-CSCF. In this arrangement, the S-CSCF is a type of virtual switching center which, in addition, maintains the signaling traffic, characterizing the IMS in this manner, with a home subscriber server HSS and a SIP SERVLET and an OSA/PARLAY gateway. At the same time, the S-CSCF controls a media gateway control functionality MGCF and a media resource control functionality MRCF.

FIG. 3 then shows the procedural sequence during the introduction of a new service for which, according to the present invention, two operator service lists IOST and OOST can be configured in the S-CSCF. For example, the operator introduces a new monitor service which allows the user to obtain statistics about all incoming chat sessions. For this purpose, the monitor service is implemented on a new application server AS1 which can be taken into operation via an ISC (IMS Service Control) interface. A call barring service has already been set up on a further application server AS2 for a user B.

In step 1), the new monitor service is configured by means of an element manager attributable to the OAM (compare, for example, OSA/PARLAY GW in FIG. 2; service broker (SCIM) in FIG. 1) in the IOST in the S-CSCF and is there ready for operation immediately for all users who are allocated to this S-CSCF. In this exemplary embodiment, the OOST does not have an entry; however, it could have entries for services which are processed in accordance with the entries in the IOST and the HSS. In this arrangement, the IOST has essentially the SIP address of the application server AS1 as entry.

In step 2), the user B registers in the IMS, as a result of which his user data from the HSS are available in his associated S-CSCF.

In step 3) the user A then sends an INVITE message to user B in order to set up a chat session. A service logic implemented in the S-CSCF on the terminating side analyzes the incoming SIP message and finds the previously configured entry in the IOST. The filter arranged as trigger point is set in such a manner that all INVITE messages are conducted to the application server AS1.

In step 4), the application server AS1 is first contacted via the ISC interface. The AS1 operates as proxy and sends the SIP message back again to the S-CSCF. Due to the entries taken over from the HSS for the user B, the S-CSCF forwards the INVITE message to the call barring service executed on the further application server AS2 because the filter in the user profile of the user B applies to such INVITE messages. The further application server AS2 does not find user A in the call barring list and therefore sends the message back to the S-CSCF for forwarding.

In step 5), the service logic in the S-CSCF on the terminating side analyzes the incoming SIP message and does not find further entries for services either in the user profiles coming from the HSS or in the OOST. The INVITE message can thus now be conducted to user B.

In this manner, the configuration of the new service (monitor service on the application server AS1) does not require any interaction with the HSS which entails considerable simplification for the operator. There are no inconsistencies due to wrong configuration in the S-CSCF and the HSS. Since the new server has been provided for all users, this only required one entry in the IOST (or naturally also in the OOST) in each S-CSCF. Since this entry also contains a filter which allows hierarchically very powerful filtering rules, it is even additionally possible to render new services accessible only to a particular group of users. In addition, storage space is saved to a considerable extent in the S-CSCF if it is not necessary to load the same entries from the user profiles for each user which uses generally available services but only the entry configured in the IOST or the OOST can be read there.

The present example is therefore only one possible example of such services. Other services are adequately mentioned in the description for FIG. 1 under the telephony and non-telephony services running in the application layer and can be implemented analogously.

1. A switching unit in an IP multimedia subsystem, comprising:
at least one operator service list,
a new service and/or a modification in an existing service being configurable in the at least one operator service list by means of an administration unit, and the services configured in the at least one operator service list for a user registering in the switching unit being applicable to said user. B).

2. The switching unit as claimed in claim 1, wherein a first operator service list and a second operator service list are provided, processing of which is intended for different trigger-related levels of hierarchy.

3. The switching unit as claimed in claim 2, wherein all services defined in the first operator service list, then the services listed for the user in a home subscriber server and, finally, all services defined in the second operator service list are executed.

4. The switching unit as claimed in claim 1, wherein for an update of the first and/or the second operator service list, all SIP transactions already set up are executed with an old configuration level of the first and/or the second operator service list.

5. The switching unit as claimed in claim 1, wherein the operator service list comprises for each service an application address, a filtering rule and a priority allocation.

6. A method for operating a switching unit in an IP multimedia subsystem, comprising:
a) defining at least one operator service list for the switching unit;
b) configuring a new service and/or a modification in an existing service in the at least one operator service list by means of an administration unit; and
c) applying the services configured in the at least one user service list for a user registering in the switching unit to said user.

7. The method as claimed in claim 6, wherein a first operator service list and a second operator service list are defined, processing of which is intended for different trigger-related levels of hierarchy.

8. The method as claimed in claim 7, wherein all services defined in the first operator service list, then the services listed for the user in a home subscriber server and,
finally, all services defined in the second operator service list are executed.

9. The method as claimed in claim 6, wherein for an update of the first and/or the second operator service list, all SIP transactions already set up are executed with an old configuration level of the first and/or the second operator service list.

10. The method as claimed in claim 6, wherein an application address, a filtering rule and a priority allocation are entered for each service in the operator service list.
